(19) United States
(12) Patent Application Publication
(10) Pub. No.: US 2025/0124017 A1
(43) Pub. Date: Apr. 17, 2025

(54) METHOD AND SYSTEM FOR ENABLING TO STORE GENEALOGICALLY RELATED DATA WITHIN A BLOCKCHAIN NETWORK

(71) Applicant: SIEMENS AKTIENGESELLSCHAFT, MÜNCHEN (DE)

(72) Inventors: ALASTAIR ORCHARD, GENUA (IT); CORRADINO GUERRASIO, GENUA (IT)

(21) Appl. No.: 18/688,852

(22) PCT Filed: Aug. 29, 2022
(86) PCT No.: PCT/EP2022/073926

§ 371 Date: Mar. 4, 2024

Related U.S. Application Data
(60) Provisional application No. 63/240,531, filed on Sep. 3, 2021.

(51) Int. Cl. G06F 16/23

(52) U.S. Cl. CPC G06F 16/2365

(57) ABSTRACT

A method and a system for enabling the storage of genealogically related data within a blockchain network. The network is configured to generate one or more blockchains. A data structure is enabled of a transaction of a given blockchain to include a data field, hereinafter called genealogical data field. The genealogical data field is configured to have a set of directed links to one or more other blockchains foreseen to be in a genealogical relationship with the given blockchain. At least one of the data items in the genealogical field refers to an intellectual property item.

The invention relates to a method and a system for enabling to store genealogically related data within a blockchain network according to the preamble of claims 1 and 4, respectively.

One of the main tasks of Product Lifecycle Management (“PLM”) platforms is the capability of tracing the progress of the product through the design process.

Several PLM systems are built on SQL-type databases, which enable creating the relationships, required to represent the design process. A drawback of such PLM platforms is that the ability to write, update and delete records may make them a mutable reference in the long term.

In some industries, like the microelectronics and semiconductor industries, their typical value chain spans multiple actors, e.g. actors for providing instruction sets, chips, packages, chipsets, systems, i.e., the manufacturing process is typically spread across multiple proprietary PLM systems.

A drawback of having multiple proprietary PLM platforms is that they cannot be queried in a holistic manner to answer critical questions of provenance.

In supply chain management systems, blockchain technologies are used for tracking and tracing of products in an automatic, fast and secure manner.

In fact, the distributed and secure nature of the blockchain lends itself extremely well to the traceability of the material assets used in the manufacture of products across multiple stakeholders e.g. from farm to fork.

Therefore, tracking solutions based on blockchain technologies are widely deployed by many of the largest international manufacturing, retailing and logistics companies.

European Patent Application EP20177851 (EP 3920115 A1), the disclosure of which is herein incorporated by reference, teaches an innovative technique for obtaining a structured meta-data model implemented within a blockchain ledger.

Embodiments of this technique teach how a set of genealogical relationships can be stored in a blockchain ledger to represent the evolution of material assets. The model obtained by this technique contains one-to-many and/or many-to-one relationships between entities and allows tracking a manufacturing process by using the blockchain technology, even in case more than two actors are involved in the transactions, as it often occurs e.g. in microelectronics and semiconductor industries.

Advantageously, by applying embodiments of this technique it is possible to prove that a physical microelectronic or semiconductor product is genuine and was produced according to the relevant design.

A problem with the above-mentioned industries is that there is a separation of the value chain of a product into the virtual and physical realms under the ownership and control of different companies, entities and/or actors often located in different countries. The physical realm includes all the material lots, manufacturing process and logistics related to a product, which may be denoted herein as physical and/or logical items, or simply physical items. The virtual realm includes the various operations related to the design of an item from the genesis of an idea to the development of the set of detailed instructions required by the manufacturer, e.g. the requirements, the specification, the design, the validations etc. The data capturing these various processes are often referred to as “Intellectual Property” data. Just like for physical genealogies, the set of data comprising Intellectual Property is complex, distributed and connected through one-to-many and many-to-one relationships that form a tree.

In some industry scenarios, unfortunately, a design itself may either arrive from a supplier with a security flaw already built-in, e.g. the so-called “backdoor”, or the design itself may be modified by an actor once in the possession of the contract manufacturer, e.g. such actor is the so-called “bad actor”.

It is therefore the aim of the present invention to overcome the above mentioned drawbacks, in particular by providing a method enabling creating an immutable record of the one-to-many/many-to-one relationships involved in the process of turning a requirement to idea and to design and enabling that it may be retrieved and evaluated with preferably a unique query on the ledger.

The aforementioned aim is achieved by a method and a system for enabling to store genealogically related data within a blockchain network, said network being configured to generate one or more blockchains; comprising enabling a data structure of a transaction of a given blockchain to comprise a data field, hereinafter called genealogical data field, said genealogical data field being configured to comprise a set of directed links to one or more other blockchains foreseen to be in a genealogical relationship with the given blockchain. At least one of the data pieces in said genealogical data field refers to an Intellectual Property item.

Furthermore, a computer program element can be provided, comprising computer program code for performing steps according to the above mentioned method when loaded in a digital processor of a computing device.

Additionally, a computer program product stored on a computer usable medium can be provided, comprising computer readable program code for causing a computing device to perform the mentioned method.

Embodiments enable to implement a structured meta-data model within a blockchain ledger.

Embodiments enable to store family tree relationship information and data in a blockchain.

Embodiments enable to store a genealogical relationship among items within the core ledger of a blockchain.

Embodiments enable a blockchain ledger to store a genealogy of relationships among linear chains.

Embodiments enable to store genealogical data models within the core ledger of a blockchain.

Embodiments enable the use of blockchain technology for storing inter-chains genealogy information.

Embodiments enable to implement a MOM genealogical data model within a blockchain ledger.

Embodiments enable building smart contracts of blockchain technologies capable of recording a genealogy of items.

Embodiments enable automatic, efficient and fast track & trace of transactions and of actions via blockchain applications associated with a product lifecycle.

Embodiments provide an efficient solution to the macro problem of product tracking and tracing between the many stakeholders in a supply chain.

Embodiments enable both forward and back tracing of a location of an item, physical/logical or virtual, in a fast manner.

Embodiments enable applying blockchain to tracing assets and the genealogy of their design throughout production processes.

Embodiments enable use of blockchain technology for non-linear genealogical item tracking by analyzing their meta-data tagging.

Embodiments enable storing genealogically related data in a secure manner thanks to the security level proper of blockchain technology.

Embodiments make use of the achievement of stage gates in the workflow of each of the PLM systems as a secure set of data sources from which to create a single, immutable, end-to-end record.

Embodiments leverage the ability of some blockchain engines, e.g. hyperledger, multichaindb, to store more than one chain within the same network.

Embodiments include:
evaluating the meta-data tagging each transaction entering the network, and
when a unique context is detected, creating a new chain and forming a link between parent and child chains that match the input and output actors of the transaction.

As the skilled in the art knows, the “context” of the transaction is substantially represented by those meta-data or tags. Some of those tags can be considered permanent characteristics (e.g. the type of material), whereas some are transient (e.g. where the material is). When a transaction context includes modifications to the transient context characteristics, it is appended to the existing chain that represents the permanent characteristics. This means that each chain shows the changes occurring to that material. If the context of the transaction includes a change to the permanent characteristics, then it essentially a new traceable entity and a new chain is created and is linked to the chains representing the entities from which the new entity is derived.

Advantageously, in embodiments, when a designer combines a characteristic of design X and a characteristic of design Y, a new chain Z is created representing the new combined design Z.

In embodiments, the design X, Y, Z are preferably characterized as follows:
the design X may be represented in the system by an existing chain (parent chain) Chain_X;
the design Y may be represented in the system by an existing chain Chain_Y;
the design Z may be represented by a newly created chain (child chain) Chain_Z.

In embodiments, the new chain Chain_Z may preferably be created with an encrypted reference to the hashes of both parent chains Chain_X, Chain_Y.

In embodiments, a corresponding reverse relation is created in the parent chains Chain_X, Chain_Y.

Otherwise stated, each blockchain comprises at least one transaction with a set of links to chain identifiers for linking itself to one or more child or parent chains.

In embodiments, the links are explicitly created by a blockchain smart contract.

In embodiments, such created links may not use the inbuilt (linear) linking mechanisms between transactions within a single chain.

In embodiments, such links advantageously retain the same encryption levels of the standard data model, guaranteeing the integrity of the overall phylogenetic network.

Embodiments include a query mechanism able to iterate back along the network of chain relations in order to find which requirement were used to produce a final design.

Embodiments make use of the presence of the reverse relationships to enable to trace forwards to identify all the final designs generated by an initial set of requirements.

Embodiments are compatible with the technique taught in European Patent Application EP20177851 regarding a structured meta-data model implemented within a blockchain ledger.

Embodiments enable that queries extend from the virtual realms to the physical realms and identify the current location of all material lots (wafers, chips, packages, chipsets, systems, etc.) thus derived.

Embodiments may advantageously prevent a design to arrive from a supplier with a security flaw already built-in, e.g. the so called “backdoor”.

Embodiments may prevent that a design itself be modified by a “bad actor” once in the possession of the contract manufacturer.

Embodiments enable to represent of a phylogenetic tree of intellectual property in a blockchain ledger.

Compared to classic PLM systems, embodiments provide:
a) immutability of the record. This characteristic is particularly critical when dealing with systems whose designs could be altered for example for spying on the military or civilians.
b) end-to-end visibility across multiple stakeholder processes without the need for a central authority.

Compared to classic blockchain-based solutions, embodiments enable to store the complex relationships between Intellectual Property elements and allow for their rapid validation.

Embodiments enable the usage of blockchain technology to unlock the advantages over classic PLM systems as mentioned in items a), b).

The invention will now be described in preferred but not exclusive embodiments with reference to the accompanying drawings, in which:

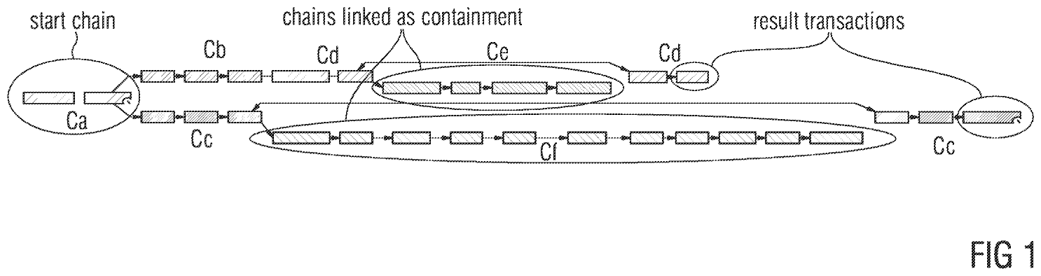

FIG. 1 is a drawing schematically illustrating the complexity of interactions between a consortium of stakeholders;

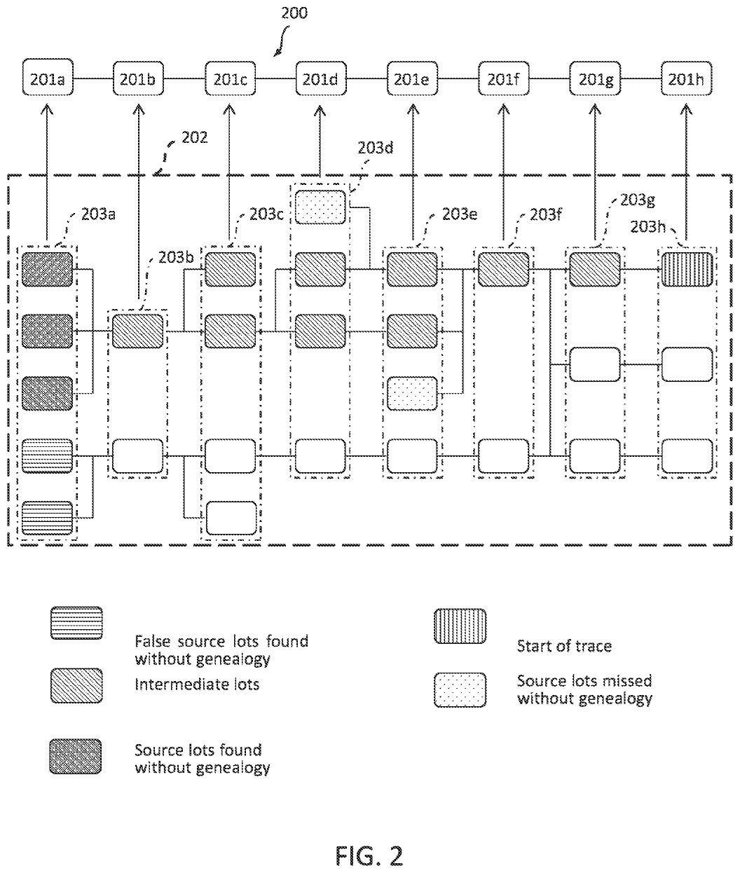

FIG. 2 is a drawing schematically illustrating a genealogy of blockchain;

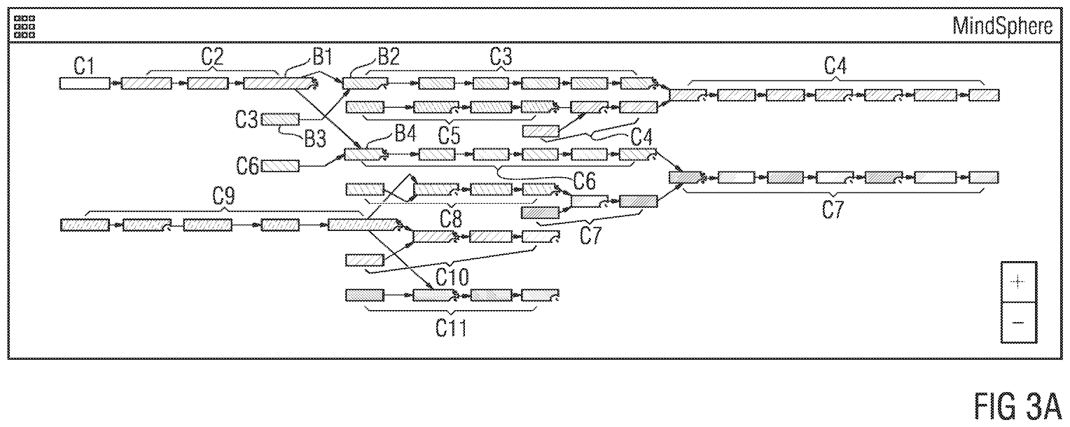

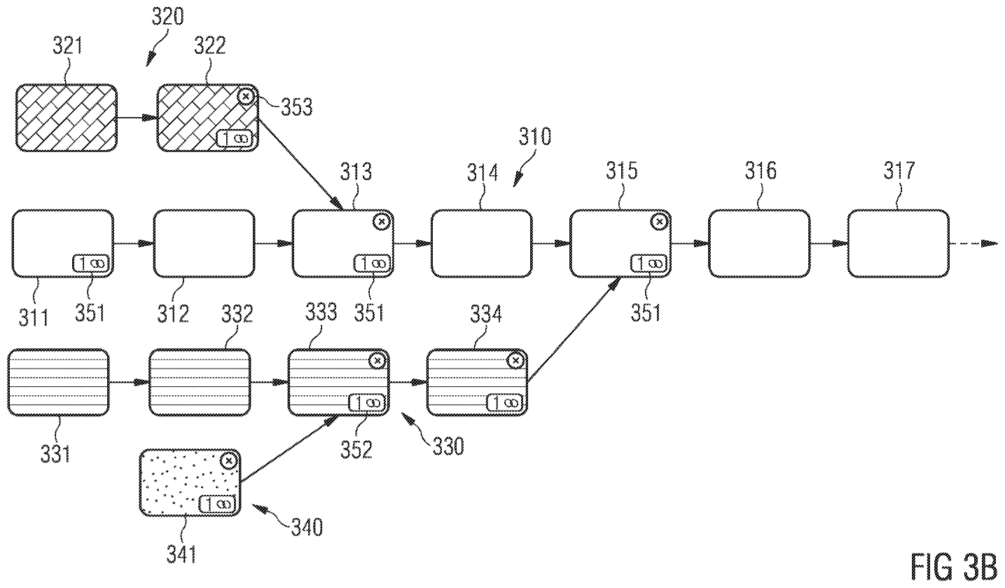

FIGS. 3A, 3B are drawings illustrating screenshots of genealogies of blockchains;

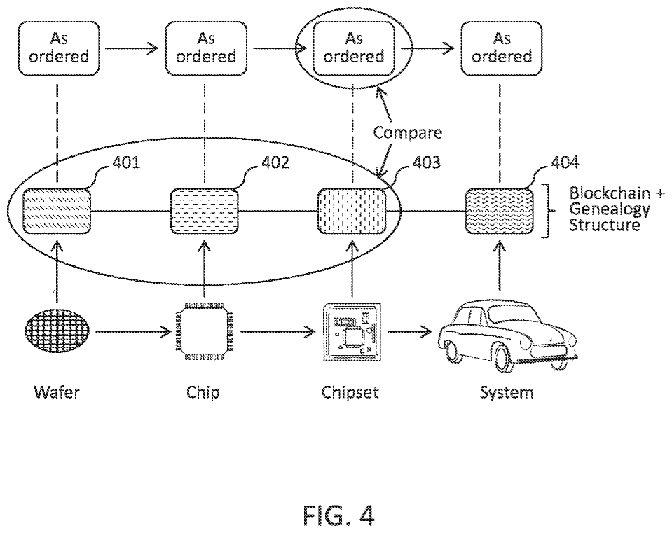

FIG. 4 is a drawing schematically illustrating an exemplary case of structured meta-data model implemented within blockchain ledger; and

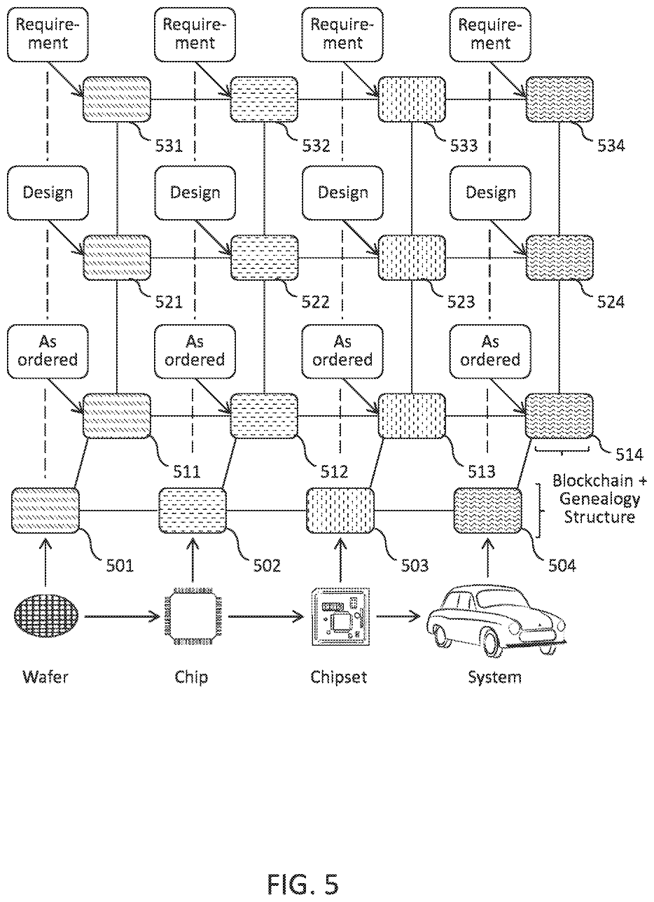

FIG. 5 is a drawing schematically illustrating an exemplary case in accordance with the invention.

As said above, a consortium of stakeholders can create a “trustless” record of the complex network of interactions that occur within and between their companies.

FIG. 1 is a drawing schematically illustrating the complexity of interactions among a consortium of companies.

The Figure shows a screenshot of a genealogy of blockchains generated in accordance with the invention, as it appears on a GUI screen. The invention creates the links between linear blockchains, generating a tree structure representative of the genealogy.

It is noted that FIG. 1 is obtained by transforming an original colorful drawing in color format, where different colors were allotted to different blockchains, to a greyscale color format. Therefore, colors which look similar in FIG. 1 are marked with reference signs “Ca” for “color a” of the original colorful drawing, “Cb” for “color b”, “Cc” for “color c”, and so on.

Embodiments enable the development of a trusted supply chain and of operational security standard for the purchase of microelectronics products and services.

European Patent Application EP20177851 teaches a technique in which structured meta-data are used to store the material genealogy of an assembled or processed product in a blockchain.

The genealogy, or family-tree, describes the multi-generational relationships between all the material lots used to transform say milk from a farm in Country_A, raw chocolate from a plantation in Country_B, Vanilla pods from Country_C and sugar cane from a consortium of growers in Country_D into processed chocolate, then into candy bars, before being packaged, palletized and distributed to retailers. Querying that structured meta-data may allow product provenance to be proven, recalls to be performed and transparency to be provided to consumers.

FIG. 2 is a drawing schematically illustrating a genealogy of blockchain and shows a backwards trace of a final material lot in order to identify its input materials.

In FIG. 2, reference 200 denotes a blockchain of grouped material lot transactions (blocks 201a to 201h). The blockchain without the related genealogy information may show only temporal relations (the lines connecting adjacent blocks 201j, j=a, b . . . h) and not causal relations, which would unfortunately lead to incorrect track and trace results.

The causal relations can be obtained by the genealogy information, the whole of which is shown by the blocks within dashed thick line box 202 below blockchain 200. In box 202, dash-and-dot thin line boxes 203j (j=a, b . . . h), associated each with a block 201j as indicated by the arrows, show in exploded manner the lot transactions grouped in the associated block 201j. A box 203j thus shows the genealogy for the corresponding block 201j.

The blocks with a texture pattern filling in boxes 203j show the lots involved in the trace, and the different texture pattern fillings of the blocks correspond to different situations of lot transactions, the meaning of which is indicated in the bottom part of the Figure. The white blocks are not involved in the trace.

FIGS. 3A-B are drawings schematically illustrating a genealogy of blockchain generated in accordance with the teachings of above-mentioned European Patent Application EP20177851, as they appear on a GUI screen.

More particularly, FIG. 3A shows the screenshot of a real example. Similarly to FIG. 1, FIG. 3A is obtained by transforming an original colorful drawing in color format, where different colors were allotted to different blockchains, into a greyscale color format. The different colors of the original colorful drawing are here identified by reference symbols “C1” to “C11”.

The blocks where chains of different colors are linked together (e.g. the chains marked B1, B2, B3 and B4) are blocks where the permanent context characteristics change, as explained above.

FIG. 3B, corresponding to FIG. 3 of European Patent Application EP20177851, shows a fictitious embodiment of a graphical blockchain representation of an extended supply chain for the production of potato chips. That supply chain comprises four different genealogically interconnected blockchains, e.g. the potato chips chain 310, the frying oil chain 320, the flavoring chain 330 and the salting chain 340. The blocks in each individual blockchain are marked by the same texture pattern filling, different from that of the other blockchains.

This Figure too clearly shows the links between different chains at certain transaction blocks. Not all links are explicitly shown. The presence in a block of links to another chain, whether or not they are explicitly shown, is indicated with a chain symbol 351 accompanied by a number indicating the number of linked chains.

The detailed description of the Figure can be found in the specification of Eapplication EP20177851 and it is not reported here for the sake of simplicity.

Advantageously, the blockchain allows the various actors, e.g. farmers, logistics, processing and packaging facilities, distributors and retailers, to collaborate in building an end-to-end set of relationships without a central authority.

Moreover, the immutable nature of the data stored in a blockchain conveniently ensures that records cannot be altered after-the-fact to obscure liability.

When applying the solution to other industries, including aerospace and automotive, a problem arises in the microelectronics and semiconductor industry, on which aerospace and automotive strongly depend. In such industries, for example, “bad actors” may supply chipsets (or PCB, i.e. electronic boards containing hundreds or thousands of chips) for sensitive applications, e.g. governmental or military, that contain rogue elements capable of bypassing security protocols.

FIG. 4 schematically illustrates an exemplary case of structured meta-data model implemented within a blockchain ledger, in case of application to the automotive industry.

References 401 to 404 denote the whole of the blockchain and the genealogy for each of a number of physical items in an exemplary and extremely simplified supply chain starting from the semiconductor wafers and resulting in a whole system, i.e. a car, passing through intermediate products consisting in chips and chipsets. Each block 401-404 in the Figure corresponds therefore to the combination of the structures denoted by references 200 and 204 in FIG. 2. The different blockchains are identified by different texture pattern fillings.

Advantageously, embodiments of blockchain-based genealogies enable to trace the provenance of each component (i.e. the as-built information) and to compare it against the “as-ordered” information of the chipset (the item potentially containing a rogue element, as assumed here), as shown in FIG. 4.

Unfortunately, the bad actors could potentially alter the “as-ordered” information to include the rogue component. In such a case, the genealogy would match the reference and the hack would unfortunately go unnoticed.

Securing the “as-ordered” information in the blockchain may not be good enough, because it represents the end of a long tree of related milestones (or stage-gates) that start with the as-required, then as-designed, as-engineered and as-planned for each of the wafers, chips, chipsets and finally systems, before the as-ordered information is released to the fabrication facility.

The traceability problem is a genealogy spanning across multiple stakeholders, and embodiments enable to apply a blockchain-based structured meta-data to the virtual items, (e.g. requirement, design, Bill of Process, Manufacturing Order, which are also known as Intellectual Property elements or items of the design process) and not only to the material lots and other physical items of the supply-chain process.

The skilled in the art knows that securing Intellectually Property in the blockchain is known. By using the analogy of an MP3 file, storing an original digital file in the blockchain is also known, a.k. as NFT. Embodiments may enable to store the relationship between the file and the computer that encoded it from the master recording, then the relationship between the master and all the instruments used in the recording session, as well as the musicians that played them. Embodiments would enable to tie in the music manuscripts they were reading from, and relate them back to the composer. Advantageously, the MP3 file is not only genuine, but it also represents the musical intent of the composer.

Coming back to the trusted traceability case, we need both the physical genealogy and embodiments regarding the virtual item genealogy to be implemented in order to fully protect the customer.

FIG. 5 schematically illustrates an exemplary case in accordance with embodiments.

FIG. 5 shows the extension of the physical genealogy to cover the whole genealogy of the Intellectual Property. By way of example, three IP items have been considered in the Figure, namely the requirement, the design and the manufacturing order. Clearly, in real cases, the IP genealogy could be more complex. Embodiments thus enable to verify the provenance e.g. of the electronic components and also their designs.

Embodiments ensure that no material substitutions have been performed in the manufacturing or logistics processes and also that the process of going from requirement to manufacturing order is secure.

In other words, referring again to FIG. 4, once the user has created the genealogy for the blockchain(s) relevant to the physical items, he/she must be sure that it is correct, i.e. that the product contains the materials provided for in the design, has been produced according to all production steps provided for in the design, has been produced in the amount requested by the production order, etc. To this end, it is necessary to compare each step in the blockchain with a reference. The main reference is the order, hence the comparison between the genealogy and the order (or, more precisely, the production blueprint in the order) is made. To be sure that nobody alters the order, the production blueprint too is to be saved in the genealogy, as indicated by blocks “As-ordered” linked to the blockchains.

What has been stated for the physical item and the order must then be repeated for the order and the design, the design and the requirements, etc. As a result, the whole technical value chain is incorporated into the blockchain, as shown in FIG. 5, in order to ensure that a client actually receives what he/she has requested.

In FIG. 4, it is implied that the manufacturing of each electronic element is performed by the owner of the related IP. The skilled in the art knows that, in other embodiments, there might be a separation between the underlying IP of a component, the designer of the component and its manufacturer, and this creates an even more complex set of stakeholder interactions.

In a typical global “journey” of a single microelectronic component, from semi design, to semi manufacturing & packaging, PCB production, PCB distribution, on average the number of times such a component changes hands from design to delivery may be around 15.

In embodiments, the data to be stored in a blockchain may be design data, which comprise Intellectual Property data.

We remind still once that the term physical item refers to material lots and other physical components like, for example, the wafer, the chip, the chipset and the car shown in FIGS. 4 and 5. The term virtual item refers instead to the design characteristics, e.g. requirement, design, Bill of Process, Manufacturing Order etc., which are also known as Intellectual Property items.

The genealogy of the physical items is shown in the lower part of FIG. 5 (blockchains 501 to 504, corresponding to blockchains 401 to 404 shown in FIG. 4).

The genealogy of the virtual items, i.e. the phylogenetic tree of Intellectual Property for each physical item considered in this Example, is shown in the upper part of FIG. 5 (blockchains 511 to 514, 521 to 524 and 531 to 534 for the order, the design and the requirement, respectively).

The same texture pattern fillings as used for blockchains 401 to 404 in FIG. 4 has been used for all blockchains relevant to a same physical item. In embodiments, the virtual part, e.g. where there is a virtual twin, may contain physical items, a prototype, which itself may be represented with a genealogy of physical items.

The genealogy of the virtual items may store the data on all what should have happened.

In FIG. 5, the virtual genealogy and the physical genealogy are connected at certain nodes. For example, one can see the vertical virtual genealogies of the wafer, chip, chipset and system, indicated by the dashed lines. It is noted that the vertical virtual genealogies may be connected to each other, for example, the design requirements of the chipset may be linked to the design requirements of the chip.

Embodiments enable building smart contracts of blockchain technologies capable of recording a genealogy of items.

A genealogy for physical or logical items was taught in European Patent Application EP20177851.

Hereby a new item type is introduced, the virtual item, which includes Intellectual Property developments in the virtual realm.

In embodiments, a system may comprise at least a processor and a memory and receives a request for a transaction or action for a product or an item. Said system is typically connected to other devices or systems in order to form a network for exchanging information with respect to the lifecycle of the product or the item.

Examples of transactions or actions include, but are not limited by, a movement of the product or the item from a supplier to a given retailer, an action applied to the product, like its mixture with another product, or its heating within a specific range of temperatures, etc.

In embodiments, a data source for creating transactions may be a MOM system. In embodiments, a specific edge device running an application may preferably provide additional context information for the blockchain transaction data.

In embodiments, the action or transaction involves the product and the realization of the action or transaction changes a status of the product, for instance from in stock to sold, or from not heated to heated. Preferably, such product status change may be signaled with a “link type” attribute.

The request might be automatically sent by a system and comprises transaction data and customized validation rules.

The customized validation rules are preferentially automatically created by said system, from data recording and representing a change of the status of the product occurring during its lifecycle.

In embodiments, a system to record transactions on a distributed network may comprise one or more of the following:
a distributed network to which a proposed transaction is submitted;
a device for cryptographically hashing the submitted transactions based on a cryptographic algorithm; and
another device for verifying the hashed transaction; and
one or more repository for recording the verified transaction.

In embodiments, a method may further conveniently include one or more of the following steps:
recording a transaction on a distributed network;
submitting a transaction to a distributed network;
providing a cryptographic algorithm to hash a submitted transaction;
cryptographically hashing a transaction based on the provided algorithm;
verifying the hashed transactions;
recording a verified transaction in one or more repository.

Embodiments may be implemented in a large variety of different systems with various architectures and with different types of actors, with direct or indirect access to one or more blockchain networks.

The skilled in the art easily appreciates that several scenario embodiments may advantageously be foreseen whereby with a mixed combination of direct access and direct/indirect recording of transaction data in one or more blockchain network by the actor companies of a supply chain.

In embodiments, a consortium of actor companies may access directly or indirectly a first blockchain network.

In other embodiments, some of the actors of the consortium may have their own different blockchain network and their recorded transactions and blockchains may advantageously be encapsulated as placeholder blockchain within the first blockchain network.

In other scenarios, embodiments may be implemented as a service in a cloud.

In other embodiments, access to the main blockchain network may be provided as software as a service (“SaaS”).

In embodiments, the SaaS implementation may be particularly convenient given the cross-domain nature of the resulting traceability solution.

In example embodiments, actors may also be final customers who scan a bar code of a given product and are then able to trace the product supply chain by expanding the traceability graph to verify a sustainability quality level.

Embodiments enable a blockchain network to act as an ecosystem of a plurality of linear blockchains ruled by a smart contract, which foresees the definition of data field comprising a link set to a set of linear blockchains. In embodiments, the ecosystem may use same repositories and a same smart contract.

In embodiments, also third party proprietary blockchains which are ruled by another blockchain network with another smart contract may interconnected to the first network of blockchains via placeholder blockchains.

1-6. (canceled)

7. A method for enabling to store genealogically related data within a blockchain network, wherein the network is configured to generate one or more blockchains, the method comprising the following step:
enabling a data structure of a transaction of a given blockchain to include a genealogical data field, the genealogical data field being configured to include a set of directed links to one or more other blockchains foreseen to be in a genealogical relationship with the given blockchain; and
including in the genealogical data field at least one data piece that refers to an intellectual property item.

8. The method according to claim 7, wherein the blockchains foreseen to be in mutual genealogical relationship include blockchains relating both to transactions concerning physical items and to transactions concerning intellectual property items.

9. The method according to claim 7, further comprising a step of providing a query mechanism iterating back and forwards along an entirety of the genealogically related blockchains, including the one or more blockchains concerning physical items.

10. The method according to claim 7, wherein generating a blockchain comprises the steps of:
evaluating a meta-data tagging each transaction entering the network, and when a unique context is detected, creating a new chain and forming a link between parent and child chains that match input actors and output actors of the transaction.

11. A data processing system, comprising:
a processor and an accessible memory enabled to store genealogically related data within a blockchain network; and
configured to execute the method according to claim 7.

12. A computer program product stored on a non-transitory computer readable medium and comprising computer program code for causing a data processing system to perform the method according to claim 7 when the program is loaded into a memory of the data processing system and run on a processor of the data processing system.
